(19) United States
(12) Patent Application Publication
(10) Pub. No.: US 2008/0244589 A1
(43) Pub. Date: Oct. 2, 2008

(54) Task manager

(75) Inventors: Scott E. Darnell, Seattle, WA (US); Michael K. Liptack, Monroe, WA (US); Jonathan A. Hoover, Kirkland, WA (US); Daniel J. Thompson, Duvall, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/729,584

(22) Filed: Mar. 29, 2007

(51) Int. Cl. G06F 9/46

(52) U.S. Cl. 718/102

(57) ABSTRACT

A task list contains information related to multiple tasks to be executed in a sequential manner. A task processor is provided to execute at least one task in the task list. A task management engine retrieves information from the task list and provides task execution instructions to the task processor. The task execution instructions provided by the task management engine are based on information retrieved from the task list. The task management engine receives execution results from the task processor and provides those results to a calling program that communicates with the task management engine.

### BACKGROUND

Various systems and processes are used to set up and install software applications on a server or other computing device. These systems and processes typically perform a series of tasks (e.g., accessing data, performing functions, and storing data) when installing software applications. Existing software set up and installation systems often include multiple integrated components, such as an installation scheduling component, an installation execution component, and information regarding various installation steps that should be performed to install a software application. These existing systems are often targeted to installing specific types of software applications and performing specific types of tasks. Many of these systems also require significant modification to support various tasks associated with different types of software applications. In many situations, it has been easier to develop a new installation system to manage the tasks associated with a new type of software application than to modify an existing system. As a result, developers have created many different application-specific installation systems.

This type of rigid structure poses problems in an environment of rapid software development. Existing installation systems that require modification for each revision of a software application place an added burden on developers each time a new revision is released. Developers are further burdened when development of new application programs requires a significant modification to tasks associated with the installation of the application program, or requires development of a completely new system to manage the new tasks.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In a particular embodiment, the technology described herein permits easy management of multiple tasks and readily accepts new tasks with little or no modification to the existing technologies. Task management functions are distributed among multiple components that are decoupled from one another. A task management engine retrieves information associated with multiple tasks from a task list. The task list also contains information regarding how to execute (or process) each task contained in the task list. The task management engine interacts with one or more task processors when managing the processing of tasks in the task list. Each task processor is associated with a particular task or a particular type of task. The task management engine coordinates the sequential processing of tasks by the task processors based on the task type associated with each task.

### BRIEF DESCRIPTION OF THE DRAWINGS

The same numbers are used throughout the drawings to reference like features.

FIG. 1 is a block diagram of a task processing environment in which various components work together to process one or more tasks.

FIG. 2 is a flow diagram illustrating an embodiment of a procedure for managing the processing of tasks.

FIG. 3 shows an example of content in a task list.

FIG. 4 is a block diagram illustrating an example computing device.

### DETAILED DESCRIPTION

The technology described herein allows a group of tasks to be easily ordered and controlled. A “task” is any step, function, or other operation that is performed by a processor, an engine, or other component. Example tasks include accessing data, storing data, manipulating data, transmitting data, launching an application program, terminating a program, activating a device, deactivating a device, and the like. The described technology is particularly useful in managing the set up and installation of software applications and when implementing a “wizard” application (i.e., an application that leads a user through a series of steps). In one example of the technology described herein, a task management engine is decoupled from one or more task processors, thereby simplifying the addition of new tasks in the future and simplifying the modification of existing tasks or installation procedures. Additionally, the task management engine is decoupled from a listing of tasks to be performed, thereby allowing a calling program to develop a list of tasks independently of the task management engine.

Particular examples discussed herein refer to the management of tasks associated with the set up and installation of a software application. However, the technologies discussed herein may be utilized in any situation requiring management of a series of tasks that need to be executed in a particular order.

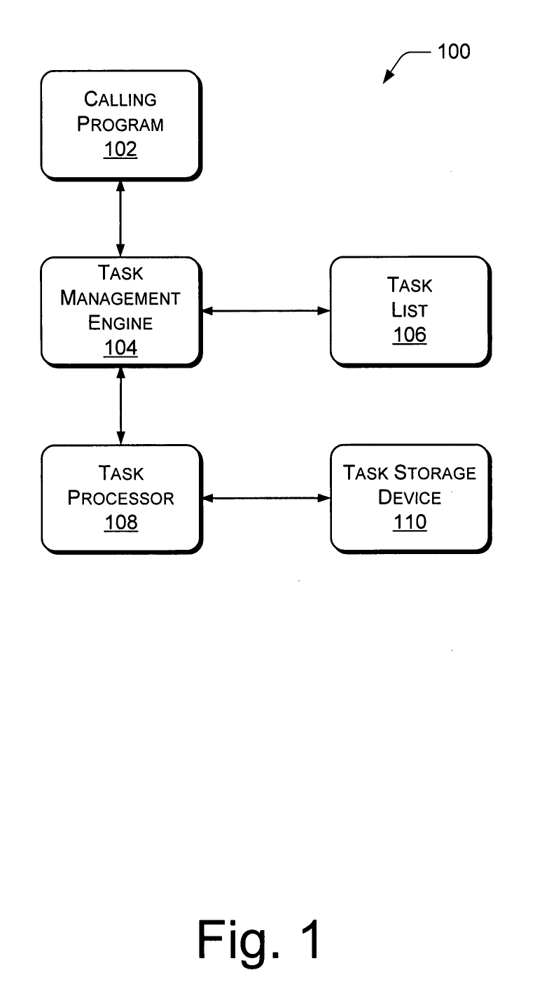

FIG. 1 is a block diagram of a task processing environment 100 in which various components work together to manage the processing of one or more tasks. Task processing environment 100 includes a calling program 102 that calls a task management engine 104. Although FIG. 1 illustrates one calling program 102, a particular task processing environment 100 may include any number of different calling programs 102 that call task management engine 104. Task management engine 104 is capable of handling a variety of different tasks. Although task management engine 104 handles a variety of tasks, the actual storage of task data and the components that handle execution of tasks are separate from task management engine 104. This decoupling of task management engine 104 from other components allows task management engine 104 to easily handle new tasks developed in the future. Additionally, task management engine 104 can continue to handle modified tasks without requiring recompilation of task management engine 104 or any other changes to task management engine 104.

Task management engine 104 accesses task-related information from a task list 106. Task list 106 may be associated with a particular calling program 102 or may contain tasks associated with multiple calling programs. Although one task list 106 is shown in FIG. 1, the task processing environment 100 may include multiple task lists 106 that are accessible by task management engine 104. As discussed in greater detail below, task list 106 includes a list of tasks to be performed by task management engine 104 and includes information related to each of those tasks. This task-related information includes, for example, the name (or identity) of the task, the location at which the task code is stored, the name of the appropriate task processor to execute the task, and the order in which the task is performed relative to the other tasks in task list 106. The order in which each task is performed can be identified by an “order attribute” associated with each task in task list 106. In an alternate embodiment, the order in which the tasks are performed is identified by the order in which the tasks appear in task list 106. For example, the first task in task list 106 is performed first, the second task in task list 106 is performed next, and so forth. The information contained in task list 106 can be stored in any data format using any data structure. Task list 106 can be modified by adding new tasks to the list, removing existing tasks from the list, or rearranging the order in which the tasks in the task list are to be executed.

Task management engine 104 also communicates with one or more task processors 108. FIG. 1 illustrates a single task processor 108. However, alternate embodiments of task processing environment 100 may include any number of task processors 108 coupled to task management engine 104. Each task processor 108 is capable of executing one or more specific tasks. “Executing” tasks may also be referred to as “processing” or “performing” tasks. As discussed above, the information associated with each task in task list 106 identifies the appropriate task processor 108 to execute the particular task. Although each task processor 108 executes specific tasks, the task processor does not necessarily include any functionality that utilizes the results obtained by executing the tasks. Task management engine 104 is responsible for managing the results produced by the various task processors 108.

Task processor 108 retrieves specific task codes (e.g., the code that is executed by the task processor to perform the specific task) from a task storage device 110. A particular task storage device may contain code and other information associated with any number of different tasks. In a particular implementation, a separate task storage device 110 is associated with each task processor 108. In another implementation, particular sections of task storage device 110 are associated with each task processor 108. Task storage device 110 may be implemented with any type of volatile or non-volatile memory or storage media. In a particular embodiment, tasks are stored in task storage device 110 using a DLL (Dynamic Link Library) format.

Task processing environment 100 provides a flexible and extensible framework for processing tasks, such as tasks associated with the set up and installation of software applications. Task processing environment 100 can manage the execution of a large number of tasks contained in one or more task lists 106. Adding new task types (or modifying existing tasks) is accomplished without requiring any change to task management engine 104. The new task (or modified task) is simply added to task list 106 along with the appropriate task-related information, and the task code is added to task storage device 110. In some cases, a new task processor 108 may be developed to execute one or more new (or modified) tasks. In other situations, the one or more new (or modified) tasks in task list 106 can be executed by one or more existing task processors 108. For example, if the execution order of multiple tasks changes based on changes to information in task list 106, the same task processors 108 are used to execute the multiple tasks. However, if a new type of task is added to task list 106 which cannot be processed by existing task processors 108, a new task processor 108 will be created for that new type of task. If a new task processor 108 is created, task management engine 104 will automatically learn of this new task processor 108 based on task-related information contained in task list 106.

Task management engine 104 is a sequential task execution engine that expects the appropriate task processor 106 to have the functionality necessary to execute particular tasks. Thus, task management engine 104 itself need not have the functionality required to execute a particular task.

The various components shown in FIG. 1 are described with respect to their operation and interaction with other components and devices. These various components can represent software modules, hardware modules, functional blocks, functional components, groupings of multiple functions, or any combination thereof.

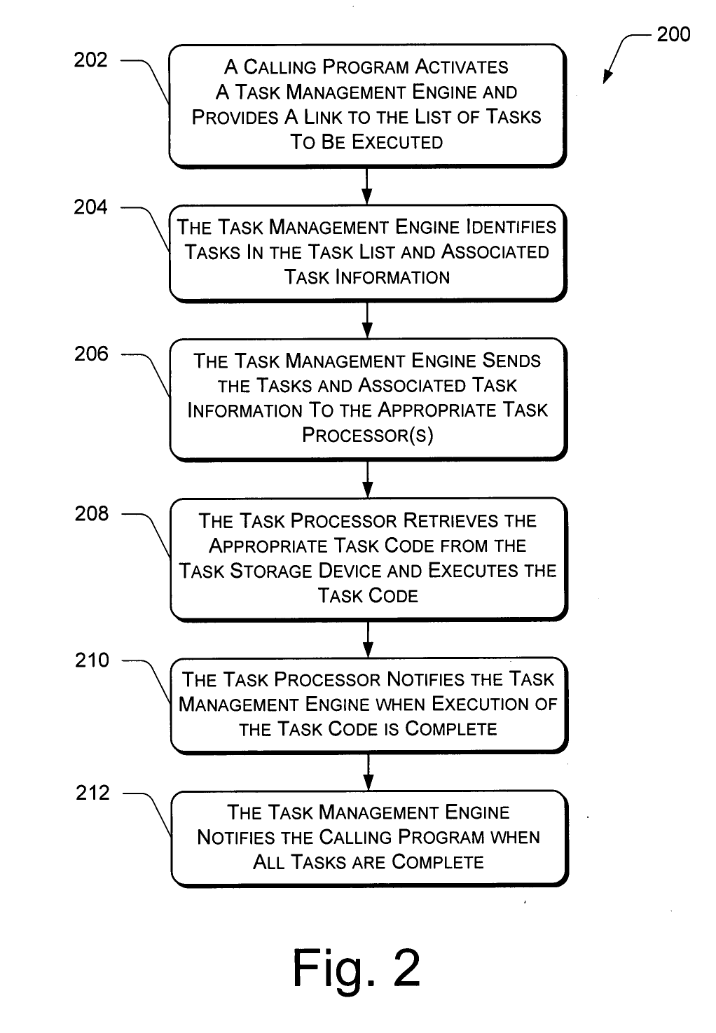

FIG. 2 is a flow diagram illustrating an embodiment of a procedure 200 that includes various operations that may be performed in managing the processing of tasks. The following description of FIG. 2 is made with reference to processing environment 100 of FIG. 1. However, it will be understood that the procedure described with respect to FIG. 2 is not intended to be limited to being performed by processing environment 100 or by any particular component or group of components of processing environment 100. Additionally, it should be understood that while procedure 200 indicates a particular order of steps, in other implementations the steps may be ordered differently.

Prior to performing procedure 200, a task list is generated (e.g., task list 106 in FIG. 1) that identifies a list of tasks to be executed when task management engine 104 is called by calling program 102. This task list 106 can be generated, for example, by a user (such as the developer of calling program 102), another application program, or another system.

Initially, calling program 102 activates task management engine 104 and provides a link to task list 106, which contains a list of tasks to be executed (block 202). The link to task list 106 identifies, for example, the name and location of task list 106. Task management engine 104 then identifies tasks in task list 106 and task information associated with those identified tasks (block 204). As task management engine 104 identifies tasks in task list 106, the task management engine 104 loads the tasks from task list 106. Task management engine 104 then sorts the tasks based on their “order attribute”—an attribute that identifies the numeric ordering of the associated task.

Based on the task information identified by task management engine 104, the tasks (and associated task information) are sent to the appropriate task processor 108 (or processors) by task management engine 104 (block 206). In a particular embodiment, task management engine 104 provides a task identifier that uniquely identifies the task to the appropriate task processor 108.

Procedure 200 continues as task processor 108 retrieves the appropriate task code from task storage device 110 and executes the task code (block 208). When execution of the task code is complete, task processor 108 notifies task management engine 104 that the task was successfully completed (block 210). If the task did not operate correctly or generated errors during execution, that information is also communicated to task management engine 104. Finally, task management engine 104 notifies calling program 102 when all tasks are complete (block 212). Task management engine 104 may also report any errors or improper operation that occurred during execution of the multiple tasks to calling program 102. In other embodiments, any errors or improper operation are stored in a log file associated with task list 106 or calling program 102.

The technology discussed herein supports a rich variety of task functions. For example, the described technology supports tasks that request an immediate reboot or a reboot after all tasks are completed. In these situations, appropriate state information (discussed below) is maintained such that the next task is properly run after the reboot and the proper progress bar state is maintained.

In the described implementation, task management engine 104 utilizes information contained in task list 106 to perform its task management functions. Task list 106 is an extensible markup language (XML) based ordering and description of multiple tasks. Creating a task in the task list includes creating a name (or identifier) for the task, assigning a unique ID to the task, and identifying a path to the task code (e.g., the binary). Additionally, the task list identifies a particular order in which the tasks should be executed. Although task list 106 is discussed herein using XML as an example, alternate implementations may use any type of data structure, data elements, or language to define task list 106.

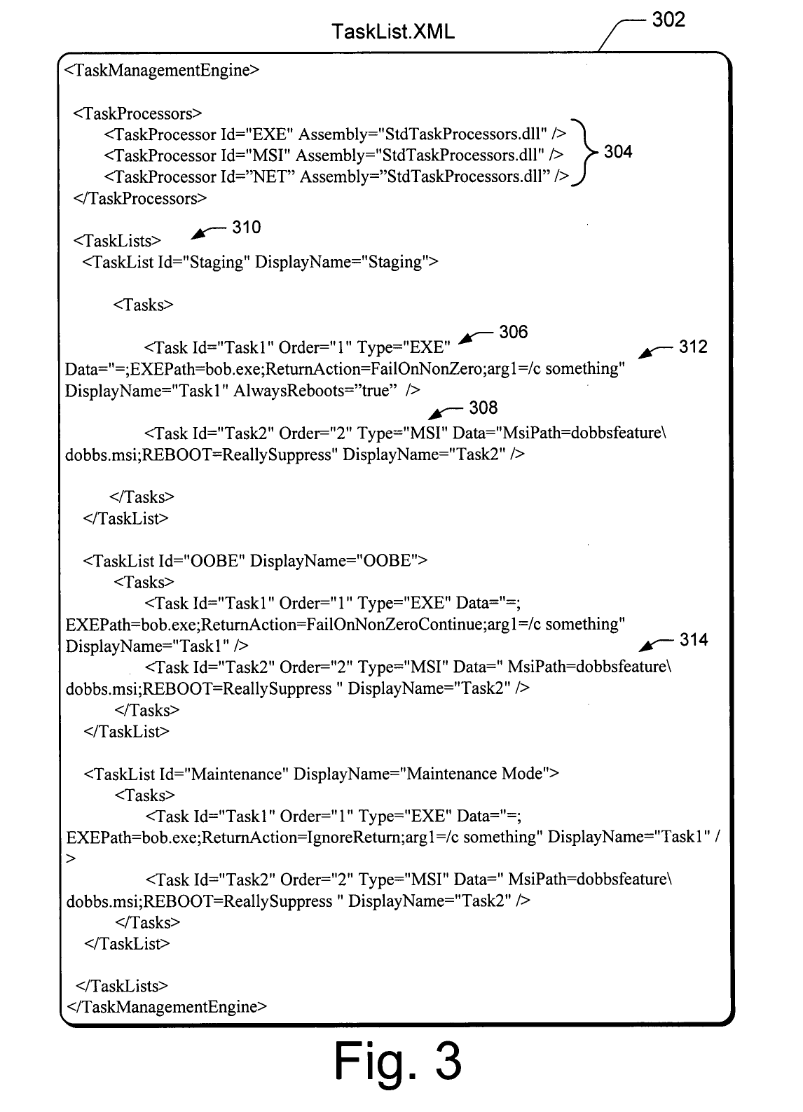

FIG. 3 shows an example of specific content maintained in an XML based task list 302. The technologies described herein use various data files to store information and to communicate information between different tasks and procedures. For example, TaskList.XML file 302 discussed herein and illustrated in FIG. 3 describes various tasks to be performed, the order in which the tasks are performed, and the appropriate task processor to execute each task. Another type of data file, referred to as an “information file” stores various information that is communicated between different tasks. For example, when one task is finishing its operation, it may have generated data that is needed by the next task to operate properly. That data is stored in the information file and is accessible to subsequent tasks even though the previous task has been completed.

Specific portions of task list 302 are discussed below to provide examples of the types of information and attributes that may be contained in task list 302. Task list 302 identifies three different task processors 304, identified as “EXE”, “MSI”, and “NET”. These three task processors 304 are useful in a Windows® installation environment. In other environments, additional task processors may be added to task list 302 and/or existing task processors may be deleted from task list 302.

The EXE task processor handles the execution of tasks that are “*.exe” executable files. The MSI task processor, handles the execution of Windows® Installer packages. Windows Installer packages are components of the Microsoft® Windows® operating system that simplify the application installation process. The .NET task processor handles execution of functions located in “.NET assemblies”. “.NET assemblies” contain all of the files that define a .NET application. “.NET” is a platform developed by Microsoft Corporation of Redmond, Wash. that incorporates applications, a suite of tools, and various services.

The “Type” attribute associated with each task identifies a task processor that is used to perform the task. For example, reference 306 identifies the point in task list 302 that assigns Task1 as type “EXE”. Thus, Task1 is processed by the task processor having an Id of “EXE”. The “Order” attribute associated with each task identifies the order in which the task is processed in relation to the other tasks in task list 302. Reference 306 identifies the point in task list 302 that assigns Task1 with an order attribute of “1”. Thus, Task1 is the first task in task list 302 to be processed. Similarly, Task2 has an order attribute of “2” (see reference 308), thereby causing Task2 to be the second task in task list 302 to be processed. A “Data” attribute associated with each task identifies the data used by the task processor to perform this task.

Each “TaskList Id” element is used to determine which “TaskList” is processed by task management engine 104. The “DisplayName” attribute identifies what will be displayed to the user while this TaskList is being processed. Referring to reference 310, a TaskList Id is “Staging” and the name displayed to the user when the task list is being processed by task management engine 104 is also “Staging”.

An “AlwaysReboots” attribute, when set to “true”, causes the task management engine to save the state of the task management engine as if the task had just finished being processed. The task management engine then generates a “RebootRequired” event indicating that the calling program should only prepare for a reboot, but not actually reboot. The “AlwaysReboot” attribute is useful with applications that always want to perform a reboot operation after particular set up or installation activities. Typically these applications do not otherwise provide a way to suppress the reboot operation.

The “Data” attribute associated with the EXE task processor (see reference 312) includes multiple elements that provide information regarding where the task data is located, how to process the task, and how to handle various errors or other issues that may occur during processing of the task. Example elements of the “Data” attribute 312 include “EXEPath”, “ReturnAction”, “Display Name”, and other parameters. In this example, the “EXEPath” element is set to a path associated with the executable file that is run by task processor 108. The “ReturnAction” element is set to one of several possible values depending—the value determines an action taken by task processor 108 upon completion of the task. Example actions taken by task processor 108 include instructing the task management engine 104 to stop processing additional tasks (e.g., if an error was detected by task processor 108), reporting an error to task management engine 104 (or another component), or reporting a successful task completion to task management engine 104.

The “Data” attribute associated with the MSI task processor (see reference 314) includes multiple elements that provide information regarding the task, such as task storage location and how reboot requests are handled by task processor 108. The .NET task processor handles execution of function calls to methods located in .NET Assemblies. When the NET task processor detects an error, the error is reported to the task management engine 104.

During execution of task management engine 104, the task management engine 104 may create one or more data files, such as a “results file” and an “engine state file”. The results file stores information regarding the results of each task, such as whether the task completed successfully, generated one or more errors, failed to complete successfully, or caused the system to be rebooted. The information contained in the results file is accessible by other systems or algorithms, for example, to analyze the results of one or more tasks handled by task management engine 104. The engine state file maintains information regarding the current state of task management engine 104 as well as previous states of the task management engine. The results file and the engine state file allow users to review the current and historical performance of various tasks handled by the task management engine.

In certain situations, when a task is being performed, that task may issue an instruction to reboot the system. In this situation, task management engine 104 maintains control over whether the system is rebooted. For example, task management engine 104 may receive an instruction to reboot the system from a task, but will suppress that request until a future time, thereby allowing other tasks to complete their operations before rebooting the system. In other situations, task management engine 104 may immediately reboot the system upon receiving the reboot instruction because such rebooting is necessary to allow the current task to complete its normal operations.

When rebooting the system, the task management engine stores its current state in the “engine state file” (discussed above) such that the task management engine's state can be restored after the system is rebooted. The engine state file contains the data necessary to restart the task management engine and return the engine to its pre-reboot state.

Three general types of task processors 108 are discussed above. However, any number of different task processor types may be used in the same manner as described herein. Other task processor 108 examples include a service task processor and a network task processor. The service task processor may, for example, handle starting and stopping of various services during a setup process. The network task processor handles, for example, starting and stopping network components (e.g., network adapters), determining network status, and the like. Any number of other task processors can be provided to handle any type of task or group of tasks.

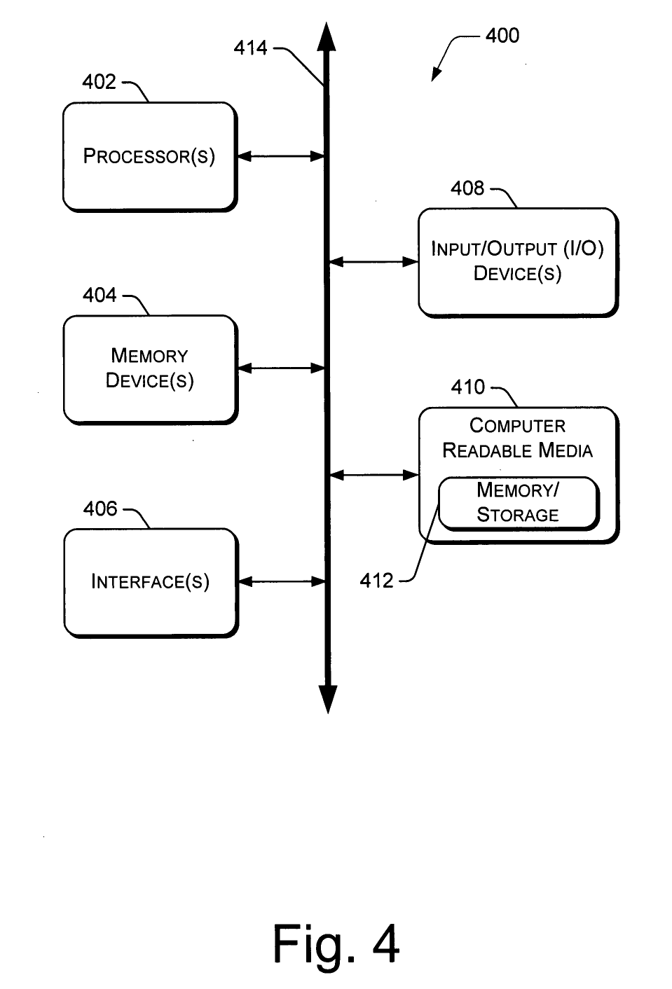

FIG. 4 is a block diagram illustrating an example computing device 400. Computing device 400 is capable of implementing various procedures, such as those discussed herein. Computing device 400 can function as a server, a client, or any other computing entity. Computing device 400 can be any of a wide variety of computing devices, such as a desktop computer, a notebook computer, a server computer, a handheld computer, and the like.

Computing device 400 includes one or more processor(s) 402, one or more memory device(s) 404, one or more interface(s) 406, one or more Input/Output (I/O) device(s) 408, and one or more computer readable media 410, all of which are coupled to a bus 414. Processor(s) 402 include one or more processors or controllers that execute instructions stored in memory device(s) 404 and/or computer readable media 410.

Memory device(s) 404 include various computer readable media, such as volatile memory (e.g., random access memory (RAM)) and/or nonvolatile memory (e.g., read-only memory (ROM)). Memory device(s) 404 may also include rewritable ROM, such as Flash memory.

I/O device(s) 408 include various devices that allow data and/or other information to be input to or retrieved from computing device 400. Example I/O device(s) 408 include cursor control devices, keyboards, keypads, microphones, monitors or other display devices, speakers, printers, network interface cards, modems, lenses, CCDs or other image capture devices, and the like.

Interface(s) 406 include various interfaces that allow computing device 400 to interact with other systems, devices, or computing environments. Example interface(s) 406 include any number of different network interfaces, such as interfaces to local area networks (LANs), wide area networks (WANs), wireless networks, and the Internet.

Computer readable media 410 includes one or more memory/storage components 412. Component 412 can include volatile media and/or nonvolatile media. Additionally, component 412 can include fixed media (e.g., RAM, ROM, a fixed hard disk, etc.) as well as removable media (e.g., a removable hard drive, a Flash memory drive, an optical disk, and the like).

Bus 414 allows processor(s) 402, memory device(s) 404, interface(s) 406, I/O device(s) 408, and computer readable media 410 to communicate with one another, as well as other devices or components coupled to bus 414. Bus 414 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 400, and are executed by processor(s) 402. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

“Communication media” typically embody computer readable instructions, data structures, program modules, or other data in a modulated data signal, such as a carrier wave or other transport mechanism. Additionally, communication media may include any information delivery media. The term “modulated data signal” describes a signal that is altered in a manner that encodes information in the signal. Communication media examples include wired media (such as a wired network or a direct-wired connection) and wireless media (such as RF, acoustic, and infrared). Combinations of any of the above are also included within the scope of computer readable media.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a task list that contains information related to a plurality of tasks to be executed in a sequential manner;
a task processor to execute at least one task in the task list;
a task management engine coupled to retrieve information from the task list and coupled to provide task execution instructions to the task processor, the task execution instructions being based on information retrieved from the task list, the task management engine receiving task execution results from the task processor and providing those results to a calling program that communicates with the task management engine.

2. An apparatus as recited in claim 1 wherein the task management engine is not capable of executing tasks.

3. An apparatus as recited in claim 1 wherein the task management engine is capable of suppressing reboot instructions until the task processor has completed processing a current task.

4. An apparatus as recited in claim 1 wherein the task list contains task name information.

5. An apparatus as recited in claim 1 wherein the task list contains information related to task identification and a task execution order.

6. An apparatus as recited in claim 1 wherein the task processor executes a first type of task.

7. An apparatus as recited in claim 1 further comprising a second task processor to execute a second type of task.

8. A method comprising:
receiving a request to execute a series of tasks from a calling program, wherein the request includes identification of a task list;
identifying information associated with tasks in the series of tasks to execute;
identifying a task processor associated with each task in the series of tasks to execute;
sequentially sending each of the tasks in the series of tasks to the associated task processor;
receiving notice upon completion of each of the tasks; and
notifying the calling program when all tasks in the series of tasks are complete.

9. A method as recited in claim 8 further comprising receiving task execution progress updates from each task processor.

10. A method as recited in claim 8 wherein multiple tasks are associated with an identified specific task processor.

11. A method as recited in claim 8 wherein identifying information associated with tasks in the series of tasks to execute includes identifying a task identifier and a task execution order.

12. A method as recited in claim 8 further comprising storing data generated during execution of a first task for use by subsequent tasks.

13. A method as recited in claim 8 further comprising modifying the tasks contained in the task list without modifying the calling program or any task processors.

14. A method as recited in claim 8 further comprising storing errors generated during execution of the series of tasks.

15. A method comprising:
receiving a request to execute a series of tasks, to the request including an identification of the series of tasks;
identifying information associated with tasks in the series of tasks to execute;
identifying a task processor associated with each task in the series of tasks to execute;
sequentially sending information associated with each of the tasks to the associated task processor;
receiving a reboot request;
suppressing the reboot request while the task processor associated with a current task is executing the current task;
receiving notice upon completion of the current task; and
initiating a reboot operation.

16. A method as recited in claim 15 further comprising storing state information associated with a task management engine prior to initiating a reboot operation.

17. A method as recited in claim 16 further comprising restoring state information associated with the task management engine after completing the reboot operation.

18. A method as recited in claim 15 further comprising storing task information associated with the series of tasks prior to initiating a reboot operation.

19. A method as recited in claim 15 wherein the information associated with tasks in the series of tasks to execute includes information related to task identification and task execution order.

20. A method as recited in claim 15 further comprising receiving task execution progress updates from each task processor.
